(19) United States
(12) Patent Application Publication
(10) Pub. No.: US 2026/0362173 A1
(43) Pub. Date: Nov. 12, 2026

(54) NCR Operations During Control Link Failure

(71) Applicant: Apple Inc., Cupertino, CA (US)

(72) Inventors: Ankit BHAMRI, Haar (DE); Hong HE, San Jose, CA (US); Haitong SUN, Saratoga, CA (US); Wei ZENG, Saratoga, CA (US); Dawei ZHANG, Saratoga, CA (US); Huaning NIU, San Jose, CA (US)

(21) Appl. No.: 19/491,891

(22) PCT Filed: Jun. 27, 2024
(86) PCT No.: PCT/US2024/035704

§ 371 Date: Dec. 10, 2025

Related U.S. Application Data
(60) Provisional application No. 63/510,971, filed on Jun. 29, 2023.

(51) Int. Cl. H04W 24/04; H04W 72/1263; H04W 72/232

(52) U.S. Cl. CPC H04W 24/04; H04W 72/1263; H04W 72/232

(57) ABSTRACT

An apparatus configured to determine a beam failure of a control link with a base station, perform a beam recovery operation for the control link, wherein the beam recovery operation comprises a beam failure recovery (BFR) or a radio link failure (RLF) operation and determine a forwarding operation for a first data link with a user equipment (UE), wherein the forwarding operation is performed during a time from the beam failure of the control link until the beam recovery operation for the control link is complete.

### PRIORITY/INCORPORATION BY REFERENCE

This application claims priority to U.S. Provisional Application Ser. No. 63/510,971 filed on Jun. 29, 2023, and entitled “NCR Operations During Control Link Failure,” the entirety of which is incorporated by reference herein.

### BACKGROUND

Network controlled repeaters (NCRs) play an important role in 5G networks by repeating signals in locations poorly served by a typical base station. NCRs act as relays in both the uplink and downlink with both base stations (e.g., a gNB) and user equipment (UEs). NCRs may have an NCR-MT (mobile termination), which is a functional entity that communicates with a gNB via a control link (e.g., c-link), which carries control information between the gNB and the NCR. The control link information may be used to control the behavior of an NCR-Fwd via downlink control information (DCI).

An NCR may have an NCR-Fwd, which is a functional entity that communicates with the gNB via a backhaul link. The NCR-Fwd may also communicate with a UE via an access link. The NCR-Fwd operates in both the uplink and downlink with both the gNB and the UE. For example, the gNB may transmit data that is bound for the UE (e.g., downlink) via the backhaul link to the NCR-Fwd. The NCR Fwd may then forward the data to the UE via an access link. Similarly, the UE may transmit data that is bound for the gNB (e.g., uplink) to the NCR-Fwd via the access link, which is then forwarded to the gNB from the NCR Fwd via the backhaul link.

In some scenarios, the control link between the gNB and the NCR-MT may fail (e.g., beam failure), but the backhaul and access links may still be functional. Improvements to NCR behavior for such scenarios are needed.

### SUMMARY

Some example embodiments are related to an apparatus having processing circuitry configured to determine a beam failure of a control link with a base station, perform a beam recovery operation for the control link, wherein the beam recovery operation comprises a beam failure recovery (BFR) or a radio link failure (RLF) operation and determine a forwarding operation for a first data link with a user equipment (UE), wherein the forwarding operation is performed during a time from the beam failure of the control link until the beam recovery operation for the control link is complete.

Other example embodiments are related to a network controlled repeater (NCR) having a transceiver configured to communicate with a base station and a user equipment (UE) and a processor communicatively coupled to the transceiver and configured to determine a beam failure of a control link with the base station, perform a beam recovery operation for the control link, wherein the beam recovery operation comprises a beam failure recovery (BFR) or a radio link failure (RLF) operation and determine a forwarding operation for a first data link with the UE, wherein the forwarding operation is performed during a time from the beam failure of the control link until the beam recovery operation for the control link is complete.

### BRIEF DESCRIPTION OF THE DRAWINGS

FIG. 1 shows an example network arrangement according to various example embodiments.

FIG. 2 shows an example UE according to various example embodiments.

FIG. 3 shows an example base station, according to various example embodiments.

FIG. 4 shows a first beam diagram for periodically configured forwarding and semi-persistent forwarding during beam failure recovery (BFR) or radio link failure (RLF) according to various example embodiments.

FIG. 5 shows a second beam diagram for aperiodic/dynamically configured forwarding during BFR or RLF according to various example embodiments.

FIG. 6 shows a third beam diagram for aperiodic/dynamically configured forwarding during BFR or RLF according to various example embodiments.

FIG. 7 shows a fourth beam diagram for aperiodic/dynamically configured forwarding during BFR or RLF according to various example embodiments.

FIG. 8 shows a method diagram according to various example embodiments.

### DETAILED DESCRIPTION

The example embodiments may be further understood with reference to the following description and the related appended drawings, wherein like elements are provided with the same reference numerals. The example embodiments relate to data forwarding operations for network controlled repeaters (NCRs) during beam recovery operations for a control link between the NCR and a base station.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol (e.g., 6G networks), or any other type of network.

As described above, an NCR may communicate with a gNB via a control link. Information communicated to the NCR via the control link may contain control information for the NCR-Fwd. Additionally, the NCR-Fwd may communicate with the gNB via a backhaul link and a UE via an access link. Throughout this description, references to link failure may also be referred to as beam failure (BF) and/or radio link failure (RLF).

The example embodiments relate to operations and logic for the backhaul and access links following control link BF. Specifically, the example embodiments relate to logic for when beam failure recovery (BFR) and/or RLF procedures are ongoing, and logic for after a new control beam is established following the BF.

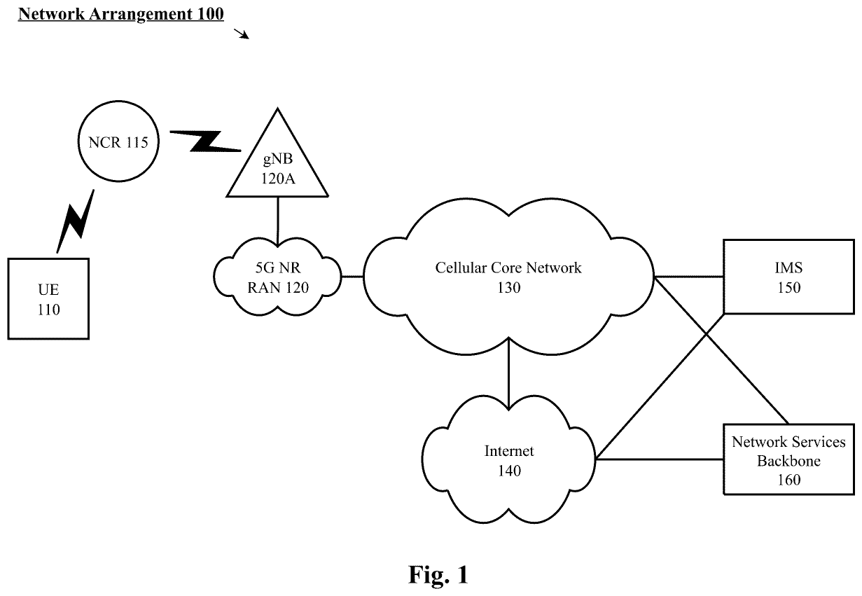

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IOT) devices, etc. An actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. The UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

The UE 110 may also communicate with the gNB 120A via a network controlled repeater (NCR) 115. The NCR 115 may receive signals from the gNB 120A and forward the signals to the UE 110. Similarly, the UE 110 may transmit signals to the NCR 115, which may forward the UE 110 signals to the gNB 120A. While the network arrangement 100 depicts the NCR 115 between the UE 110 and the gNB 120A, one of skill in the art will recognize that the UE 110 is capable of communication with the gNB 120A (or any additional gNB) without an NCR (e.g., the NCR 115).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

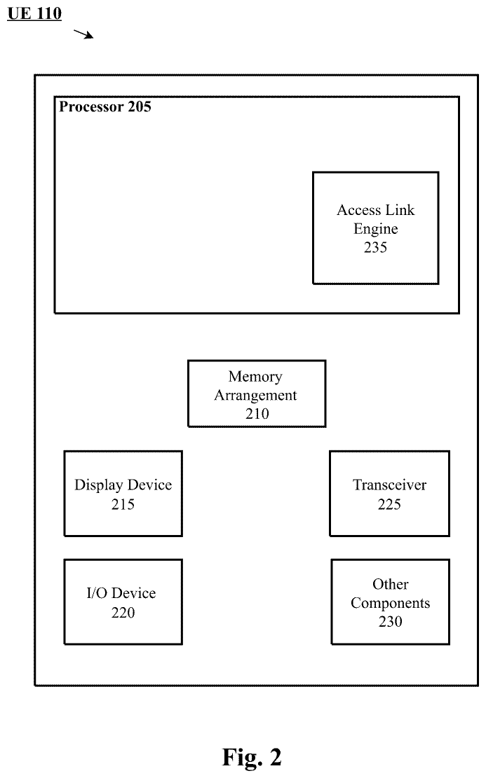

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an Access Link engine 235 for performing operations related to processing access link communications in both the uplink and downlink with the NCR 115.

The above referenced engine being an application (e.g., a program) executed by the processor 205 is only an example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

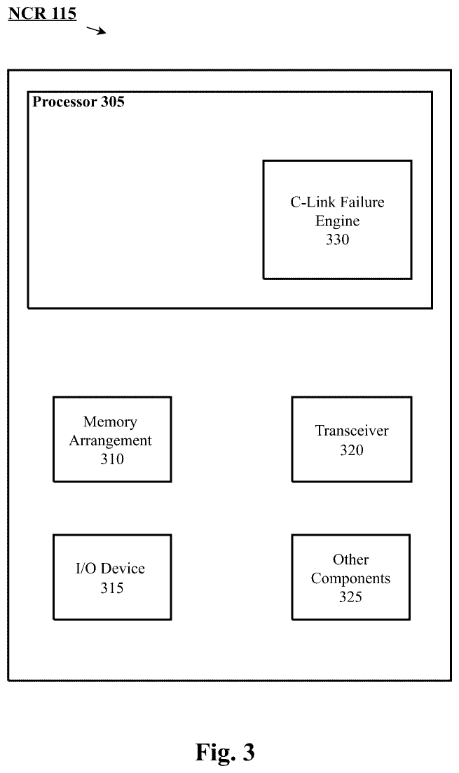

FIG. 3 shows an NCR 115 according to various example embodiments. The NCR 115 may represent a network controlled repeater that communicates with both the UE 110 and the gNB 120A.

The NCR 115 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the NCR 115 to other electronic devices and/or power sources, etc.

The processor 305 may be configured to execute a plurality of engines for the UE 110. For example, the engines may include a C-link failure engine 330 for performing operations related to management of surviving backhaul and access links during and after a control link beam failure.

The memory 310 may be a hardware component configured to store data related to operations performed by the NCR 115. The I/O device 315 may be a hardware component or ports that enable a user to interact with the NCR 115. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

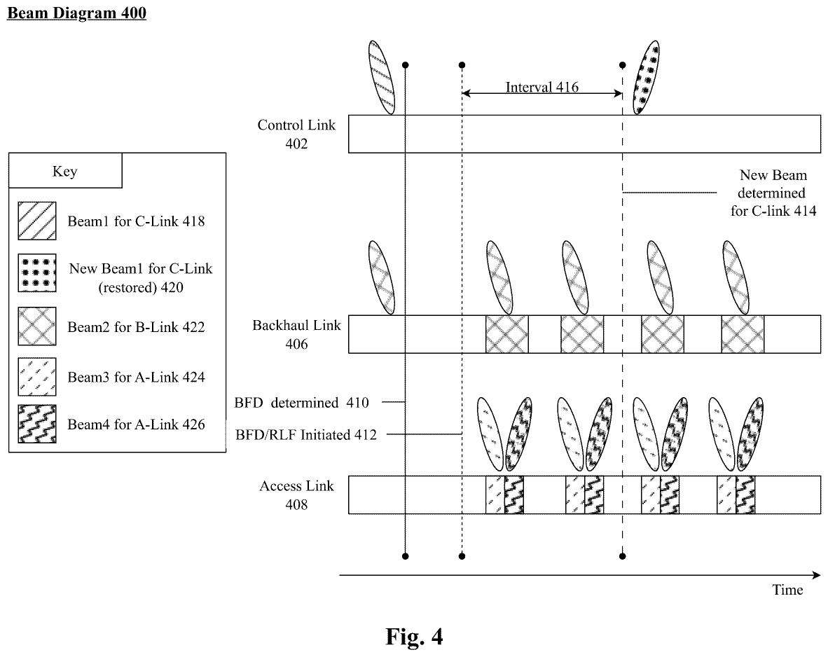

FIG. 4 shows a first beam diagram 400 for periodically configured forwarding and semi-persistent forwarding during beam failure recovery (BFR) or radio link failure (RLF) according to various example embodiments. The beam diagram 400 describes a first aspect of the example embodiments. The beam diagram 400 is described from the perspective of an NCR (e.g., the NCR 115). The first aspect may be applicable for both periodically configured forwarding (in both the downlink and uplink) and semi-persistent forwarding that is already activated. It should also be noted that the NCR-MT is capable of detecting beam failure and performing beam recovery operations in both the first aspect and subsequent aspects of the example embodiments.

The beam diagram shows a control link 402, a backhaul link 406, and an access link 408. The control link 402 connects the NCR 115 (via an NCR-MT function) with a gNB (e.g., the gNB 120A). The control link 402 carries control information between the NCR 115 and the gNB 120A.

The backhaul link 406 carries uplink and downlink data to and from the gNB 120A. The backhaul link is processed by an NCR-Fwd function of the NCR 115. The backhaul link 408 uses a Beam2 for B-link 422. While the backhaul link is shown with one beam, the backhaul link could also use more than one beam.

The access link 408 carries uplink and downlink data to and from the UE 110. The access link is processed by an NCR-Fwd function of the NCR 115. The access link 408 uses two beams, a Beam3 for A-link 424 and a Beam4 for A-link 426. While the access link is shown with two beams, the access link could also use one beam, or more than two beams (e.g., a hypothetical Beam5 for A-link).

Initially, the control link 402 is actively connected between the UE 110 and the NCR 115. This initial control link 402 is maintained by a Beam1 for C-link 418.

In 410, control link beam failure is detected (e.g., the control link 402 has failed). While beam failure recovery (BFR)/radio link failure (RLF) 412 is shown with a time period occurring between it and the BFD determination 410, one of skill in the art will recognize that BFR 412 occurs as quickly as possible following BFD 410. It should again be noted that in the example embodiments, it is considered that the control link fails but the backhaul and access links survive.

In interval 416, the control link 402 is not active. In 414, the control link 402 is restored with a new beam 420. The new beam 420 may operate in a substantially similar manner as the beam1 for C-link 418 that failed.

Returning to the interval 416, logic is needed for the backhaul link 406 and the access link 408 during the interval 416 where there is no control link 402, e.g., for any scheduling occasions for forwarding data that occur during the interval 416. In this example, the scheduling occasions are periodic or semi-persistent scheduling occasions but in further examples the scheduling occasions may be aperiodic or dynamically scheduled. As described above, existing implementations rely on the control link 402 to control the backhaul link 406 and the access link 408.

In some example embodiments, because the control link 402 and the backhaul link 406 are using different beams, the backhaul link 406 may continue to operate as normal using the Beam2 for B-link 422 during the interval 416. The access link 408 may also continue forwarding operations using the Beam3 for A-link 424 and the Beam4 for A-link 426. These operations are shown in FIG. 4 by the aforementioned beams continuing to be active during the interval 416 and after the new beam is determined 414. Thus, in these example embodiments, periodically configured and semi-persistent configured transmissions of the backhaul link 406 and the access link 408 continue as if the control link 402 never experienced beam failure.

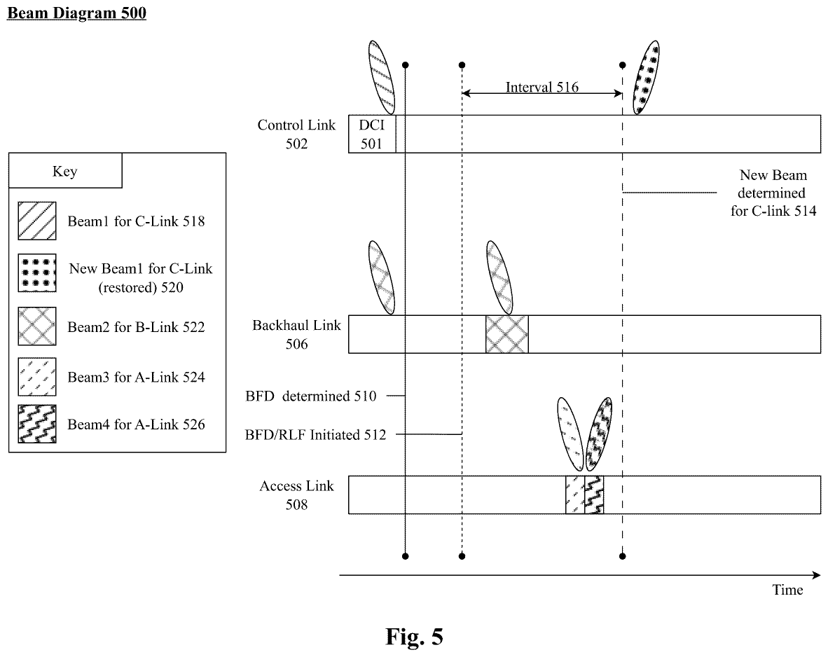

FIG. 5 shows a second beam diagram 500 for aperiodic/dynamically configured forwarding during BFR or RLF according to various example embodiments. The beam diagram 500 may describe a second aspect of the example embodiments. The second aspect of the example embodiments relate to aperiodic/dynamically indicated forwarding in both the uplink and downlink for which related control information is already received before BFR/RLF is initiated. In the second aspect, the NCR-Fwd performs forwarding on the corresponding indicated beams (from the control information) and time-domain resources.

One of skill in the art will recognize that the beam diagram 500 is substantially similar to the beam diagram 400, including the shown links (502, 506, and 508), BED and recovery operations (510, 512, and 514), as well as beams (518, 520, 522, 524, and 526). Unlike FIG. 4, the forwarding in the beam diagram 500 is aperiodic/dynamically indicated. Also of note in the beam diagram 500 is the downlink control information (DCI) 501. In this example, the DCI 501 is received at the NCR 115 before the BFD is determined in 510. The DCI 501 may include the control information for the aperiodic/dynamic forwarding.

Again, because the control link 502 and the backhaul link 506 are using different beams, the backhaul link 506 may continue to operate as normal during the interval 516. With the DCI 501, the NCR 115 may continue to perform forwarding on the access link 508 (via the Beam3 for A-link 524 and the Beam4 for A-link 526) during the interval 516 in which the BFR/RIF is being performed. For example, the Beam3 524 and the Beam4 526 may continue forwarding data aperiodically based on the DCI 501 received at the NCR 115 before the BFD 510.

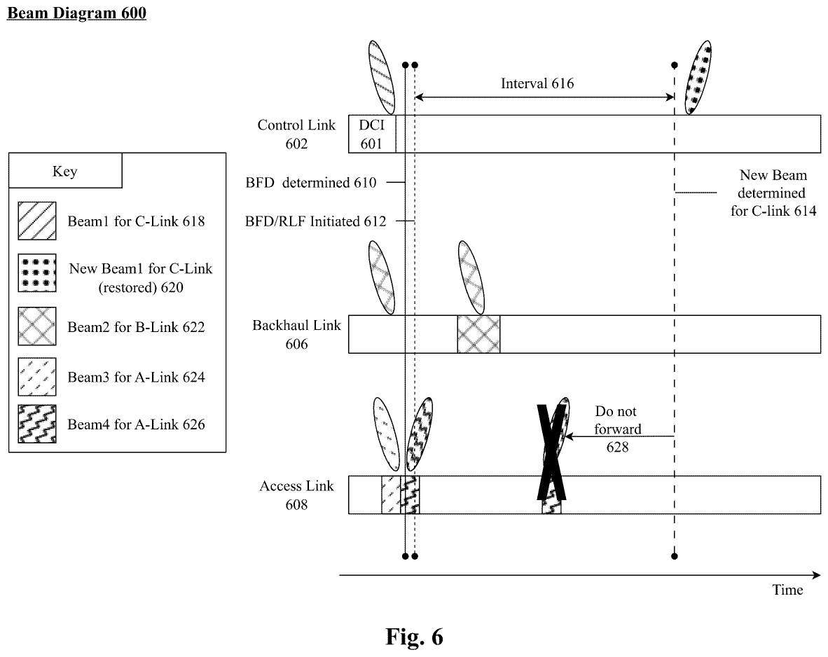

FIG. 6 shows a third beam diagram 600 for aperiodic/dynamically configured forwarding during BFR or RLF according to various example embodiments. The beam diagram 600 may describe a third aspect of the example embodiments. The third aspect of the example embodiments relate to aperiodic/dynamically indicated forwarding and post-control link failure received forwarding.

One of skill in the art will recognize that the beam diagram 600 is substantially similar to the beam diagram 500, including the shown links (602, 606, and 608), BFD and recovery operations (610, 612, and 614), as well as beams (618, 620, 622, 624, and 626) and DCI 601.

In a similar manner to the operations shown in FIG. 5, because the control link 602 and the backhaul link 606 are using different beams, the backhaul link 606 may continue to operate as normal during the interval 616, e.g., using the beam2 for the b-link 622. For the access link 608, for aperiodic/dynamic indicated forwarding in the downlink and uplink for which associated side control information (via the DCI 601) received before the BFD is determined in 610, forwarding that started before and is ongoing during the interval 616 may continue. For example, the first instance of the combination of beam3 624 and beam4 626 that started before the BFR/RLF and continues after the start of the BFR/RLF (e.g., during the interval 616) may continue based on the received DCI 601 that precedes the control link 602 failure.

On the other hand, any instances of aperiodic/dynamic indicated forwarding in the downlink and uplink that are scheduled to start during the interval 616 is not forwarded even when side control information for the forwarding is received via the DCI 601 before the BFD is determined in 610. For example, as shown in FIG. 6, an instance of aperiodic/dynamic indicated forwarding, that is scheduled to begin during the interval 616 is indicated as “do not forward” 628. In this case, the forwarding for the access link 608 is not performed at 628, because this forwarding was started after the BFD determination 610.

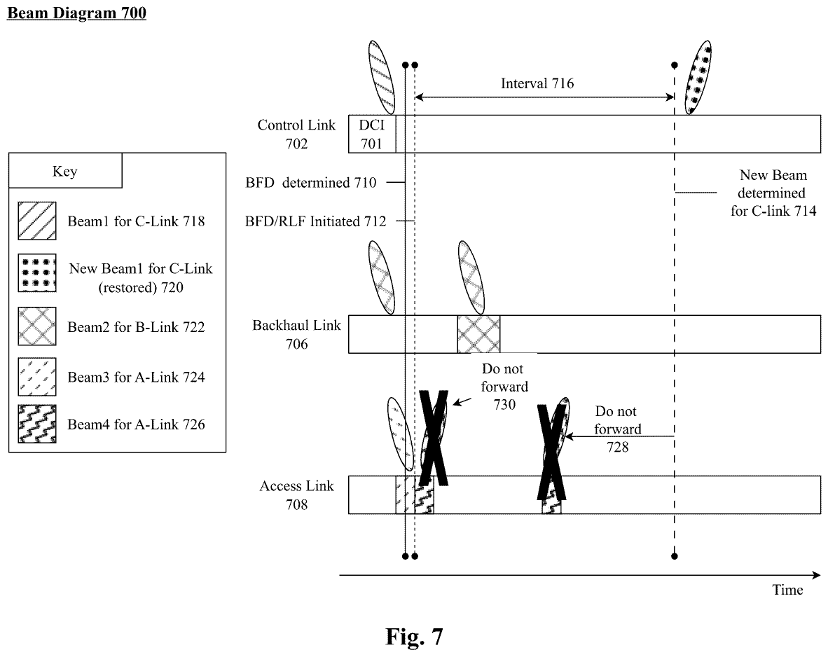

FIG. 7 shows a fourth beam diagram 700 for aperiodic/dynamically configured forwarding during BFR or RLF according to various example embodiments. The beam diagram 700 may describe a fourth aspect of the example embodiments. The fourth aspect of the example embodiments relate to aperiodic/dynamically indicated forwarding and post-control link failure received forwarding.

One of skill in the art will recognize that the beam diagram 700 is substantially similar to the beam diagram 600, including the shown links (702, 706, and 708), BED and recovery operations (710, 712, and 714), as well as beams (718, 720, 722, 724, and 726) and DCI 701.

In a similar manner to the operations shown in FIG. 6, because the control link 702 and the backhaul link 706 are using different beams, the backhaul link 706 may continue to operate as normal during the interval 716, e.g., using the beam2 for the b-link 722. For the access link 708, for aperiodic/dynamically indicated forwarding in the downlink and uplink for which associated side control information (via the DCI 701) received before BFD determination 710, forwarding that started before and is ongoing during the interval 716 may continue so long as the same access link beam is used. For example, the first instance of the beam3 724 that started before the BFR/RLF and continues after the start of the BFR/RLF (e.g., during the interval 716) may continue based on the received DCI 701 that precedes the control link 702 failure.

On the other hand, the first instance of the beam4 726 that is related to the first instance of the beam3 724 that is a different beam, is shown as “do not forward” 730 because the beam4 726 is different from the beam3 724 that started before the BFR/RLF. Similarly, any instances of aperiodic/dynamically indicated forwarding in the downlink and uplink that are scheduled to start during the interval 716 are not forwarded even when side control information for the forwarding is received via the DCI 701 before the BFD is determined in 710. For example, as shown in FIG. 7, an instance of aperiodic/dynamic indicated forwarding, that is scheduled to begin during the interval 716 is indicated as “do not forward” 728. Thus, in this case, the forwarding for the access link 608 is not performed at 728 or 730.

In a fifth aspect of the example embodiments, additional NCR-Fwd behavior and logic is disclosed herein. For periodically configured forwarding (in both the uplink and the downlink) and for semi-persistent forwarding that is already activated, forwarding at the NCR-Fwd may not be continued upon initiation of BFR/RLF procedures at the NCR-MT. For example, referring back to FIG. 4, when the fifth aspect is implemented, the instances of the beam3 424 and beam4 426 that occur during the interval 416 will not be forwarded.

In a sixth aspect of the example embodiments, additional NCR-Fwd behavior and logic is disclosed herein. The sixth aspect may be applicable for aperiodic/dynamically indicated forwarding (in both the uplink and the downlink) for which related side control information is already received before BFR/RLF is initiated at the NCR-MT as well as future forwarding instances (i.e., after BFR and before control link restoration). In the sixth aspect, forwarding is not continued at the NCR-Fwd after BFR/RLF procedures are initiated at the MCR-MT.

In all the previous aspects of the example embodiments, it was considered that the control link and the backhaul link used different beams. In a seventh aspect of the example embodiments, it may be considered that the control link and the backhaul link use the same beam(s). In these example embodiments, no forwarding is continued at the NCR-Fwd once BFR/RLF procedures are initiated at the NCR-MT.

In an eight aspect of the example embodiments, still further NCR-Fwd behavior and logic is disclosed herein. The eight aspect may be applicable to scenarios after a new beam is determined/applied following a BFR/RLF procedure. In a first option of the eight aspect, previously configured forwarding instances can be considered invalid and discarded. In the first option, the discarded forwarding instances are configured/indicated again. In a second option of the eight aspect, periodic and semi-persistent forwarding configurations may be implicitly activated upon after the new control beam is established. For aperiodic indications in the second option, all valid aperiodic forwarding indications may also still be forwarded.

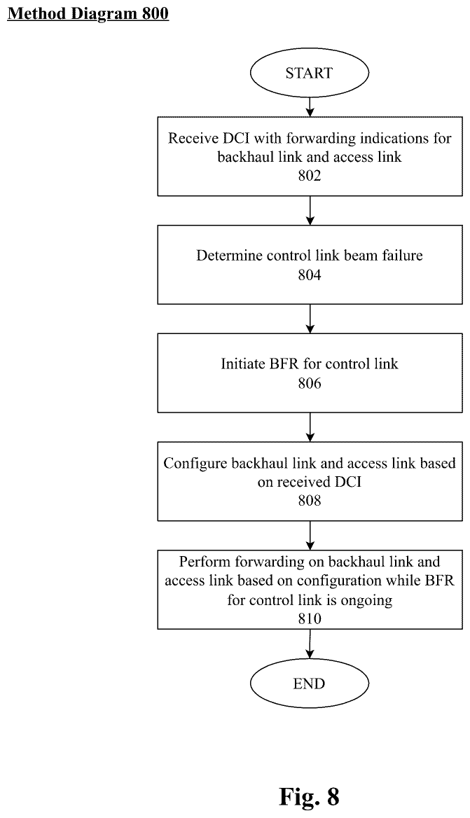

FIG. 8 shows a method diagram 800 according to various example embodiments. The method diagram 800 may be performed by an NCR, such as the NCR 115. The method diagram 800 begins with the NCR having a control link established with a gNB (e.g., the gNB 120A), a backhaul link with the gNB 120A, and an access link with the UE 110.

In 802, the NCR 115 receives downlink control information (DCI) from the gNB 120A via a control link with the gNB 120A. The DCI may contain control information for the access link and backhaul link. It should be noted that in some aspects of the example embodiments, DCI may not be received (such as the first aspect where the forwarding is periodic or semi-persistent). In such a scenario, the NCR 115 would perform forwarding without DCI.

In 804, the NCR 115 (specifically, the NCR-MT) determines a beam failure for the control link.

In 806, the NCR 115 initiates a BFR/RLF recovery procedure for the failed control link.

In 808, the NCR 115 configures the backhaul and access links based on the DCI received in 802.

In 810, the NCR performs forwarding on the backhaul and access links based on the configuration in 808 while the control link BFR operations are ongoing. It should be noted that in some variants of the example embodiments, forwarding may occur for data that was being transmitted before and during control link failure as well.

### EXAMPLES

In a first example, a method, comprising determining a beam failure of a control link with a base station, performing a beam recovery operation for the control link, wherein the beam recovery operation comprises a beam failure recovery (BFR) or a radio link failure (RLF) operation and determining a forwarding operation for a second data link with a user equipment (UE), wherein the forwarding operation is performed during a time from the beam failure of the control link until the beam recovery operation for the control link is complete.

In a second example, the method of the first example, wherein a first data link with the base station comprises a first beam and the control link comprises a second beam, wherein the first and second beam are different beams.

In a third example, the method of the second example, wherein data exchanged between the NCR and the UE is periodic scheduled data or semi-persistent scheduled data.

In a fourth example, the method of the third example, wherein the forwarding operation comprises sending data received from the base station to the UE using one or more beams during any periodic or semi-persistent scheduling occasions during the time from the beam failure of the control link until the beam recovery operation for the control link is complete.

In a fifth example, the method of the third example, wherein the forwarding operation comprises receiving data from the UE using one or more beams during any periodic or semi-persistent scheduling occasions during the time from the beam failure of the control link until the beam recovery operation for the control link is complete.

In a fourth example, the method of the third example, wherein the forwarding operation comprises skipping forwarding any data for periodic or semi-persistent scheduling occasions during the time from the beam failure of the control link until the beam recovery operation for the control link is complete.

In a seventh example, the method of the second example, wherein data exchanged between the NCR and the UE is aperiodic scheduled data or dynamically scheduled data and wherein the forwarding operation for the second data link is based on downlink control information (DCI) received via the control link before the beam failure of the control link.

In an eighth example, the method of the seventh example, wherein the forwarding operation comprises sending data received from the base station to the UE using one or more beams during any aperiodic or dynamic scheduling occasions configured by the DCI to occur during the time from the beam failure of the control link until the beam recovery operation for the control link is complete.

In a ninth example, the method of the seventh example, wherein the forwarding operation comprises receiving data from the UE using one or more beams during any aperiodic or dynamic scheduling occasions configured by the DCI to occur during the time from the beam failure of the control link until the beam recovery operation for the control link is complete.

In a tenth example, the method of the seventh example, wherein the forwarding operation comprises sending data received from the base station to the UE using one or more beams during any aperiodic or dynamic scheduling occasions configured by the DCI to begin before the time and continue during the time from the beam failure of the control link until the beam recovery operation for the control link is complete, wherein the method further comprises skipping forwarding data received from the base station to the UE during any aperiodic or dynamic scheduling occasions configured by the DCI to begin during the time.

In an eleventh example, the method of the seventh example, wherein the forwarding operation comprises receiving data from the UE using one or more beams during any aperiodic or dynamic scheduling occasions configured by the DCI to begin before the time and continue during the time from the beam failure of the control link until the beam recovery operation for the control link is complete, wherein the method further comprises skipping forwarding data received from the UE during any aperiodic or dynamic scheduling occasions configured by the DCI to begin during the time.

In a twelfth example, the method of the seventh example, wherein the forwarding operation comprises sending data received from the base station to the UE using a first beam during any aperiodic or dynamic scheduling occasions configured by the DCI to begin before the time and continue during the time from the beam failure of the control link until the beam recovery operation for the control link is complete, wherein the method further comprises skipping forwarding data received from the base station to the UE during any aperiodic or dynamic scheduling occasions configured by the DCI to begin during the time or during any aperiodic or dynamic scheduling occasions configured by the DCI to begin before the time and continue during the time when using a second beam that is different from the first beam.

In a thirteenth example, the method of the seventh example, wherein the forwarding operation comprises receiving data from the UE using a first beam during any aperiodic or dynamic scheduling occasions configured by the DCI to begin before the time and continue during the time, wherein the method further comprises skipping forwarding data received from the UE during any aperiodic or dynamic scheduling occasions configured by the DCI to begin during the time or during any aperiodic or dynamic scheduling occasions configured by the DCI to begin before the time and continue during the time when using a second beam that is different from the first beam.

In a fourteenth example, the method of the seventh example, wherein the forwarding operation comprises skipping forwarding any data for aperiodic or dynamic scheduling occasions configured by the DCI to occur during the time from the beam failure of the control link until the beam recovery operation for the control link is complete.

In a fifteenth example, the method of the first example, wherein the first data link comprises a first beam and the control link comprises the first beam, wherein the forwarding operation comprises skipping forwarding any data for any scheduling occasions configured to occur during the time from the beam failure of the control link until the beam recovery operation for the control link is complete.

In a sixteenth example, the method of the first example, wherein, when the beam recovery operation is successful, a new beam is established for the control link to the base station.

In a seventeenth example, the method of the first example, further comprising ignoring all scheduling occasions for data forwarding that were configured prior to the new beam being established.

In an eighteenth example, the method of the first example, further comprising perform data forwarding for any scheduling occasions that were configured prior to the new beam being established, wherein the scheduling occasions occur after the new beam is established.

In a nineteenth example, a processor configured to perform any of the methods of the first through eighteenth example.

In a twentieth example, a network controlled repeater (NCR) comprising a transceiver configured to communicate with a base station and a user equipment (UE) and a processor communicatively coupled to the transceiver and configured to perform any of the methods of the first through eighteenth example.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
determine a beam failure of a control link with a base station;
perform a beam recovery operation for the control link, wherein the beam recovery operation comprises a beam failure recovery (BFR) or a radio link failure (RLF) operation; and
determine a forwarding operation for a first data link with a user equipment (UE), wherein the forwarding operation is performed during a time from the beam failure of the control link until the beam recovery operation for the control link is complete.

2. The apparatus of claim 1, wherein a second data link with the base station comprises a first beam and the control link comprises a second beam, wherein the first and second beam are different beams.

3. The apparatus of claim 2, wherein data exchanged between the apparatus and the UE is periodic scheduled data or semi-persistent scheduled data.

4. The apparatus of claim 3, wherein the forwarding operation comprises sending data received from the base station to the UE using one or more beams during any periodic or semi-persistent scheduling occasions during the time from the beam failure of the control link until the beam recovery operation for the control link is complete.

5. The apparatus of claim 3, wherein the forwarding operation comprises receiving data from the UE using one or more beams during any periodic or semi-persistent scheduling occasions during the time from the beam failure of the control link until the beam recovery operation for the control link is complete.

6. The apparatus of claim 3, wherein the forwarding operation comprises skipping forwarding any data for periodic or semi-persistent scheduling occasions during the time from the beam failure of the control link until the beam recovery operation for the control link is complete.

7. The apparatus of claim 2, wherein data exchanged between the apparatus and the UE is aperiodic scheduled data or dynamically scheduled data and wherein the forwarding operation for the first data link is based on downlink control information (DCI) received via the control link before the beam failure of the control link.

8. The apparatus of claim 7, wherein the forwarding operation comprises sending data received from the base station to the UE using one or more beams during any aperiodic or dynamic scheduling occasions configured by the DCI to occur during the time from the beam failure of the control link until the beam recovery operation for the control link is complete.

9. The apparatus of claim 7, wherein the forwarding operation comprises receiving data from the UE using one or more beams during any aperiodic or dynamic scheduling occasions configured by the DCI to occur during the time from the beam failure of the control link until the beam recovery operation for the control link is complete.

10. The apparatus of claim 7, wherein the forwarding operation comprises sending data received from the base station to the UE using one or more beams during any aperiodic or dynamic scheduling occasions configured by the DCI to begin before the time and continue during the time from the beam failure of the control link until the beam recovery operation for the control link is complete,
wherein the processing circuitry is further configured to skip forwarding data received from the base station to the UE during any aperiodic or dynamic scheduling occasions configured by the DCI to begin during the time.

11. The apparatus of claim 7, wherein the forwarding operation comprises receiving data from the UE using one or more beams during any aperiodic or dynamic scheduling occasions configured by the DCI to begin before the time and continue during the time from the beam failure of the control link until the beam recovery operation for the control link is complete,
wherein the processing circuitry is further configured to skip forwarding data received from the UE during any aperiodic or dynamic scheduling occasions configured by the DCI to begin during the time.

12. The apparatus of claim 7, wherein the forwarding operation comprises sending data received from the base station to the UE using a first beam during any aperiodic or dynamic scheduling occasions configured by the DCI to begin before the time and continue during the time from the beam failure of the control link until the beam recovery operation for the control link is complete,
wherein the processing circuitry is further configured to skip forwarding data received from the base station to the UE during any aperiodic or dynamic scheduling occasions configured by the DCI to begin during the time or during any aperiodic or dynamic scheduling occasions configured by the DCI to begin before the time and continue during the time when using a second beam that is different from the first beam.

13. The apparatus of claim 7, wherein the forwarding operation comprises receiving data from the UE using a first beam during any aperiodic or dynamic scheduling occasions configured by the DCI to begin before the time and continue during the time,
wherein the processing circuitry is further configured to skip forwarding data received from the UE during any aperiodic or dynamic scheduling occasions configured by the DCI to begin during the time or during any aperiodic or dynamic scheduling occasions configured by the DCI to begin before the time and continue during the time when using a second beam that is different from the first beam.

14. The apparatus of claim 7, wherein the forwarding operation comprises skipping forwarding any data for aperiodic or dynamic scheduling occasions configured by the DCI to occur during the time from the beam failure of the control link until the beam recovery operation for the control link is complete.

15. The apparatus of claim 1, wherein a second data link with the base station comprises a first beam and the control link comprises the first beam, wherein the forwarding operation comprises skipping forwarding any data for any scheduling occasions configured to occur during the time from the beam failure of the control link until the beam recovery operation for the control link is complete.

16. The apparatus of claim 1, wherein, when the beam recovery operation is successful, a new beam is established for the control link to the base station.

17. The apparatus of claim 16, wherein the processing circuitry is further configured to:
ignore all scheduling occasions for data forwarding that were configured prior to the new beam being established.

18. The apparatus of claim 16, wherein the processing circuitry is further configured to:
perform data forwarding for any scheduling occasions that were configured prior to the new beam being established, wherein the scheduling occasions occur after the new beam is established.

19. A network controlled repeater (NCR), comprising:
a transceiver configured to communicate with a base station and a user equipment (UE) ; and
a processor communicatively coupled to the transceiver and configured to:
determine a beam failure of a control link with the base station;
perform a beam recovery operation for the control link, wherein the beam recovery operation comprises a beam failure recovery (BFR) or a radio link failure (RLF) operation; and
determine a forwarding operation for a first data link with the UE, wherein the forwarding operation is performed during a time from the beam failure of the control link until the beam recovery operation for the control link is complete.

20. The NCR of claim 19, wherein a second data link with the base station comprises a first beam and the control link comprises a second beam, wherein the first and second beam are different beams.
